(19) United States
(12) Patent Application Publication
(10) Pub. No.: US 2011/0290731 A1
(43) Pub. Date: Dec. 1, 2011

(54) CARTRIDGE CHANGERS AND METHODS FOR UTILIZING THE SAME

(76) Inventors: Can C. Ozbal, Maynard, MA (US); Arrin Katz, Cambridge, MA (US); Donald Green, Arlington, MA (US); Eduard Vernikov, Brighton, MA (US)

(21) Appl. No.: 13/116,989

(22) Filed: May 26, 2011

Related U.S. Application Data
(60) Provisional application No. 61/350,366, filed on Jun. 1, 2010.

(51) Int. Cl. B01D 15/08; G01N 30/02; B23P 19/00

(52) U.S. Cl. 210/656; 29/700

(57) ABSTRACT

Aspects of the invention provide cartridge changers and methods utilizing the same. One aspect of the invention provides a cartridge changer for a plurality of cartridges. The cartridge changer includes a cartridge holder having a plurality of receptacles each adapted to receive one of the plurality of cartridges and a pair of fittings adapted to releasably engage one of the plurality of cartridges.

### CROSS-REFERENCING

This application claims the benefit of U.S. provisional application Ser. No. 61/350,366, filed Jun. 1, 2010, which application is incorporated by reference herein.

### BACKGROUND

Chromatographic techniques are often used to separate various components of complex mixtures. Many forms of chromatography are routinely used in analytical and preparatory applications including gas chromatography (GC), liquid chromatography (LC), high-pressure liquid chromatography (HPLC), ultra high-pressure liquid chromatography (UHPLC), thin layer chromatography (TLC), and the like. Many analytical detection systems including, but not limited to, mass spectrometry, optical detection systems (e.g., absorption, fluorescence, chemo-luminescence, phosphorescence), nuclear magnetic resonance, and the like are commonly coupled with such chromatographic systems.

In various forms of liquid chromatography including HPLC and UHPLC, the separation is enacted through the use of a chromatography column or cartridge in which analytes of interest are differentially adsorbed, bound, or attracted to an immobilized solid matrix. Various separations can be achieved by washing or eluting these analytes from the solid matrix with a wide range of solvents or solutions. The separation of analytes can be modified by selection of a number of parameters including the selection of the chemical and physical properties of the solid matrix, as well as the polarity, ionic strength, and hydrophobicity of the solvent or solution used to elute analytes from the solid matrix. Other parameters such as the geometry of the solid matrix (e.g., a column or cartridge with a defined diameter and length), the flow rate and pressure of the liquid phase, and temperature will also impact the differential elution of analytes in a chromatographic system.

Many HPLC and UHPLC devices utilizing these principles are commercialized by a number of companies including Applied Biosystems, Inc. of Foster City, Calif.; Agilent Technologies, Inc. of Santa Clara, Calif.; Dionex Corporation of Sunnyvale, Calif.; PerkinElmer, Inc. of Waltham, Mass.; Shimadzu Corporation of Kyoto, Japan; Thermo Fisher Scientific Inc. of Waltham, Mass.; Waters Corporation of Milford, Mass.; and Varian, Inc. of Palo Alto, Calif. These systems commonly use a chromatography column consisting of a solid matrix, usually in the form of packed beads or a gel, immobilized within a cylindrical tube through the use of frits or filters at either end of the tube. The liquid phase is delivered to and from this chromatography column through tubing and fittings that are designed to withstand the pressures generated by the respective devices.

In many chromatography applications it is highly desirable for more than one type chromatographic column or cartridge to be used. These applications may include method development where a number of chromatography columns, each containing a different solid matrix with different chemical and physical properties, may be used to determine which one has the desired separation characteristics. In applications where a plurality of samples are to be analyzed via chromatography in a serial fashion, each sample may best be analyzed with a different type of chromatography column or cartridge. In yet another application, if a large number of similar samples are to be analyzed serially, it may be desirable to periodically use a new column or cartridge of the same type as the performance of a column may degrade after repeated use.

The fluidic connections between the column or cartridge and the pumps which deliver the liquid phase to the column or cartridge are designed to withstand the pressures that are generated by the HPLC or UHPLC device. These pressures may reach 400 bar (˜6,000 psi) in the case of HPLC and 1,000 bar (˜15,000 psi) in the case of UHPLC. To withstand these pressures without leaking the fittings are generally composed of multiple parts including ferrules and tightening nuts and may require mechanical tools such as wrenches to create an appropriate seal. In such devices replacing a single chromatography column or cartridge with another can be a time consuming and difficult operation. Moreover, the replacement of cartridges in such systems requires human interaction, which can limit the ability of users to run experiments overnight.

One solution to the problem of switching between multiple chromatography columns is to couple a specific port of a selection valve to the inlet and outlet ends of two or more chromatography columns. By selecting the appropriate ports on the two selection valves liquid phase can be diverted to the desired column or cartridge. While this approach facilitates rapid selection of a specific chromatography column or cartridge it has drawbacks in that setting up the plurality of valves and columns can be time consuming and complicated. Furthermore, the multiple valves add cost and complexity to instrument and can be a source of carryover within the fluidic system. The plurality of fluidic connections creates a larger number of potential positions where leaks may develop and increase the maintenance requirements of such systems.

Accordingly, there is a need for a system that allows for the replacement of a chromatography cartridge without human interaction.

### SUMMARY OF THE INVENTION

Aspects of the invention provide cartridge changers and methods utilizing the same.

One aspect of the invention provides a cartridge changer for a plurality of cartridges. The cartridge changer includes a cartridge holder having a plurality of receptacles each adapted to receive one of the plurality of cartridges and a pair of fittings adapted to releasably engage one of the plurality of cartridges.

This aspect of the invention has a variety of embodiments. The receptacles can be arranged substantially radially on the cartridge holder. The receptacles can be arranged substantially linearly on the cartridge holder.

The cartridge changer can include an actuator adapted to position the cartridge holder for engagement of one of the plurality of cartridges. The actuator can be adapted to rotate the cartridge holder. The actuator can be adapted to advance and retract the cartridge holder. The actuator can be an electric motor. The actuator can be a pneumatic actuator.

Each of the pair of fittings can be mounted on one of a pair of arms. The fittings can be female fittings.

The cartridges can be chromatography cartridges. One of the pair of fittings can be coupled to mass spectrometer.

The cartridge changer can include a control device configured to control the actuation of the cartridge holder and the pair of fittings to enable the selection of a specific cartridge. The cartridge changer can include one or more pressure sensors in communication with the control device. The control device can be configured to select a new cartridge when a substantially elevated pressure is detected.

Another aspect of the invention provides a method of chromatography. The method includes: providing a cartridge changer for a plurality of cartridges, the cartridge changer including a cartridge holder having a plurality of receptacles each adapted to receive one of the plurality of cartridges and a pair of fittings adapted to releasably engage one of the plurality of cartridges; loading a plurality of chromatography cartridges in the plurality of receptacles; actuating the cartridge holder to place a desired cartridge between the pair of fittings; and actuating the pair of fittings to releasably engage a first of the plurality of cartridges.

This aspect of the invention can have a variety of embodiments. The method can include actuating the cartridge holder to place a second desired cartridge between the pair of fittings. The method can include actuating the pair of fittings to releasably engage the second desired cartridge. The method can include utilizing the pair of fittings to pass a sample over the desired cartridge. The method can include utilizing the pair of fittings to pass an elution solvent over the desired cartridge.

### BRIEF DESCRIPTION OF THE DRAWINGS

For a fuller understanding of the nature and desired objects of the present invention, reference is made to the following detailed description taken in conjunction with the accompanying drawing figures wherein like reference characters denote corresponding parts throughout the several views and wherein:

FIG. 1 depicts a cartridge suitable for use with embodiments of the invention;

FIGS. 2A and 2B depict a cartridge changer according to an embodiment of the invention;

FIG. 3 depicts a cartridge holder according to an embodiment of the invention; and

FIG. 4 depicts a method of chromatography according to an embodiment of the invention.

### DETAILED DESCRIPTION OF THE INVENTION

Aspects of the invention provide cartridge changers and methods utilizing the same.

### Cartridges

As discussed herein, cartridges (e.g., chromatography cartridges) are used in a variety of research devices and processes. The invention described herein can be applied to facilitate the changing of the full variety of such cartridges as well as cartridges used in other fields. (The term “cartridge” is defined broadly herein to encompass columns such as chromatography columns.)

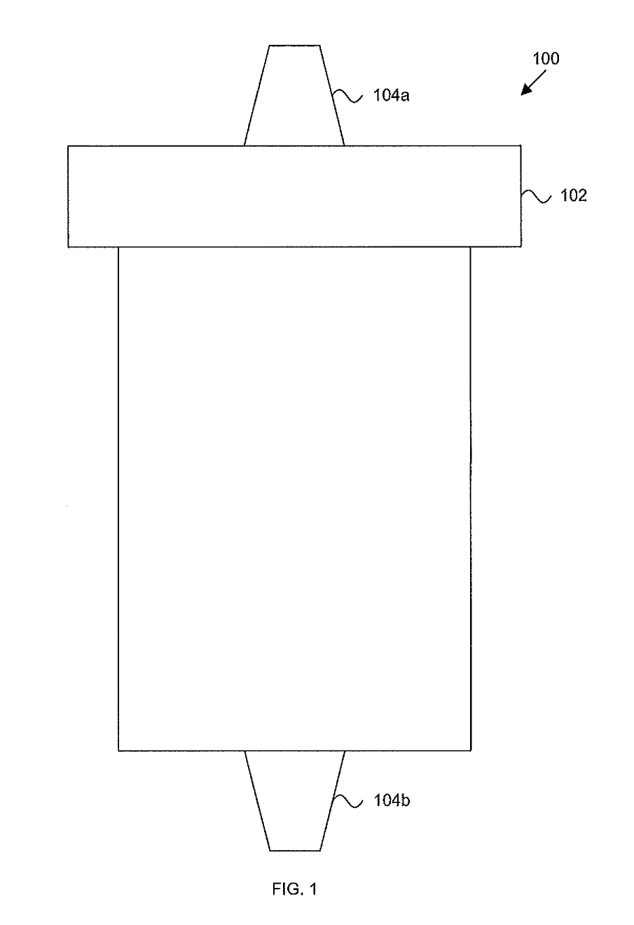

One such compatible cartridge 100 is depicted in FIG. 1. Cartridge 100 can have a substantially circular cross-section. In other embodiments, cartridge 100 has a cross-section approximating a shape selected from the group consisting of: a square, a rectangle, a triangle, an oval, a polygon, a parallelogram, a rhombus, an annulus, a crescent, a semicircle, an ellipse, a super ellipse, a deltoid, and the like.

Cartridge 100 can include a collar 102 or other feature(s) (e.g., one or more tabs) configured to retain the cartridge 100 when placed in receptacle as discussed herein.

Cartridge 100 includes two fittings 104a, 104b adapted for coupling with corresponding fittings to allow for one or more fluids to be passed over the cartridge 100. The fittings 104 can be male fittings as depicted in FIG. 1 or can be female fittings.

Cartridge 100 can be constructed from any material(s) capable of withstanding the pressures associated with the particular application of the cartridge 100. For example, cartridges 100 can be constructed from metals, plastics, and the like.

Cartridge 100 can include one or more materials adapted to interact with the materials flowed over the cartridge 100. For example, cartridge 100 can include a solid chromatography matrix as known to those of skill in the art.

Various suitable cartridges are available from Biocius Life Sciences, Inc. of Woburn, Mass. and Optimize Technologies, Inc. of Oregon City, Oreg. and are described in U.S. Pat. Nos. 5,525,303; 5,730,943; 5,911,954; 6,095,572; and 6,361,687.

### Cartridge Changers

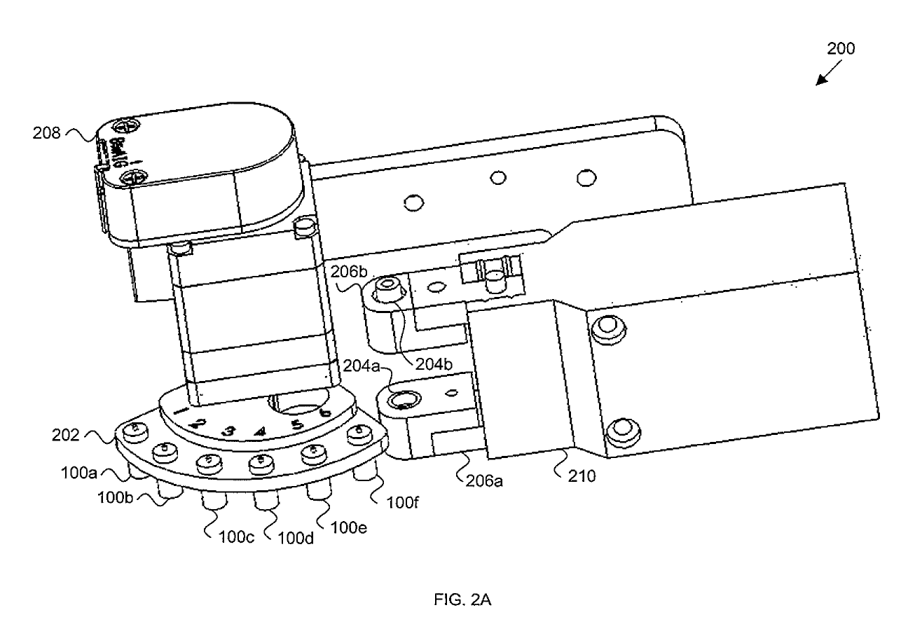

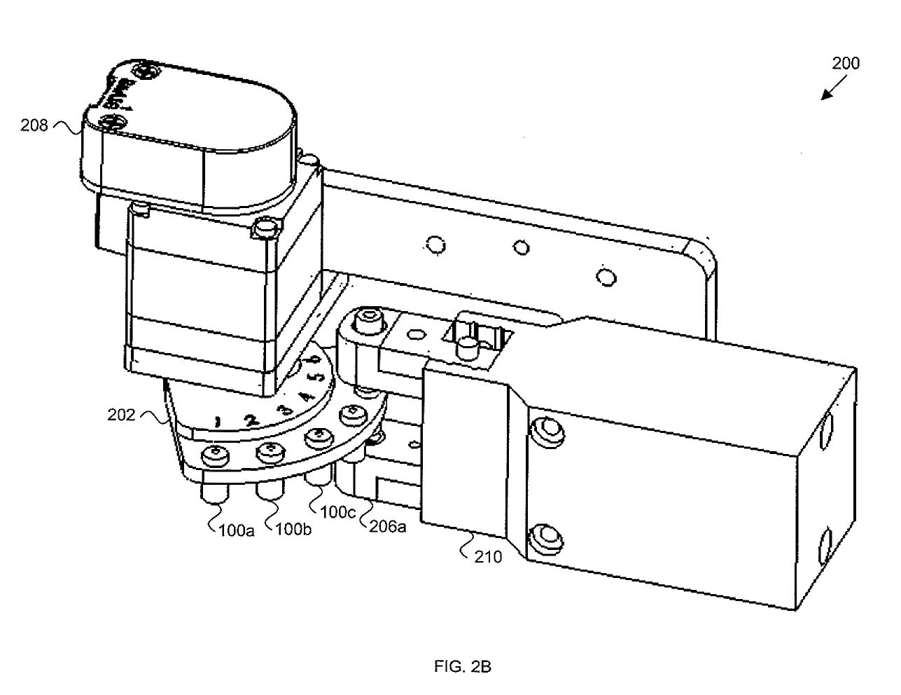

Referring now to FIG. 2A, a cartridge changer 200 in a “swap” position that allows for replacement of all cartridges 100 is depicted according to an embodiment of the invention. Cartridge changer 200 includes a cartridge holder 202 and a pair of fittings 204a, 204b.

Cartridge holder 202 includes a plurality of receptacles adapted to receive a cartridge 100. Advantageously, the cartridges 100 can be inserted into the receptacles without the need for any tools and is retained by collar 102. Cartridge holder 202 can be fabricated from materials such as metals, plastics, and the like with methods such as casting, stamping, machining, molding, and the like.

Receptacles can be arranged radially along the cartridge holder 202 as depicted in FIG. 2A such that specific cartridges 100 can be selected by rotating the cartridge holder 202 as depicted in FIG. 2B. Alternatively, receptacles can be arranged substantially linearly on cartridge holder 202 such that specific cartridges 100 can be selected by advancing or retracting cartridge holder 202.

Fittings 204 can be male or female fittings and preferably correspond to the geometry of fittings 104 on cartridge 100. Fittings 204 can be made from materials capable of forming a seal with fittings 104 and withstanding the pressure of fluid introduced to the cartridge 100. In some embodiments, the fittings 204 are fabricated from elastomers such as acrylonitrile-butadiene rubber, hydrogenated acrylonitrile-butadiene rubber, fluorocarbon rubber, perfluoroelastomer, ethylene propylene diene rubber, silicone rubber, fluorosilicone rubber, chloroprene rubber, neoprene rubber, polyester urethane, polyether urethane, natural rubber, polyacrylate rubber, ethylene acrylic, styrene-butadiene rubber, ethylene oxide epichlorodrine rubber, chlorosulfonated polytethylene, butadiene rubber, isoprene rubber, butyl rubber, and the like.

Fittings 204 can be mounted on one or more arms 206a, 206b. Arms 206a, 206b can be configured to releasably press fittings 204a, 204b, respectively against fittings 104a, 104b of cartridge 100. Arms 206 can remain substantially parallel to each other when opening and closing as depicted in FIG. 2A or can pivot on one or more hinges.

Cartridge changer 200 can be manually or automatically controlled. For example, a human can position cartridge holder 202 and/or fittings 204 to utilize a specific cartridge 100. Alternatively, cartridge changer 200 can include one or more actuators 208, 210 for moving cartridge holder 202 and/or fittings 204. Such actuators 208, 210 can be electrical, mechanical, electromechanical, or pneumatic devices as appreciated by those of ordinary skill in the art. For example, actuator 208 can be a servo. Actuator 210 can be configured to apply a variable force to fittings 204 to comply with various cartridges 200 and provide seals suitable for various operating pressures.

### Control Devices

Various embodiments of the invention include a control device configured to select a specific cartridge. The control device can be implemented in software and/or hardware.

The control device can be configured such that each sample in a plurality of samples is analyzed by a specific cartridge (e.g., a cartridge having an optimum chemistry).

Alternately, a different cartridge could be selected after a predetermined number of analyses have been completed on an initial cartridge. For example, a fresh cartridge of the same type could be selected after 100 samples are analyzed. Validation experiments may dictate that after a specific number of injections it is required to swap out the cartridge with a new one.

Active feedback could also be used in cartridge selection by monitoring the operating pressure of the chromatography device using one or more pressure sensors.

One common failure mode for chromatography columns or cartridges is the occlusion of the solid matrix bed or the frits or filters that retain the solid matrix with particulates from the sample or solvent system. This type of occlusion creates increased pressure in the chromatography system and can lead to separations with lower efficiency and resolution. The control device can be configured to automatically select a fresh cartridge if a predetermined pressure threshold is crossed. This threshold could either be an absolute pressure or a percentage increase over the standard operating pressure of the chromatography system.

### Programming

In some embodiments, the control device may be programmed to replace cartridges in accordance with user instructions that are input through a user interface. In these embodiments, prior to use, a user may specify parameters by which cartridges are replaced. For example, a user may specify the number of times a cartridge is used before it is replaced or the pressure at which a cartridge is replaced etc. The user interface may in certain cases contain fields into which a user enters instructions (e.g., by typing, by clicking a button or via pull-down menu) that specify the criteria for replacing cartridges. After the instructions are input via the user interface, the instructions may be saved. The instructions input via the user interface may be execute during use of the cartridge holder.

A tangible computer-readable medium containing instructions (i.e. “programming”) for providing instructions to the control device is also provided. The programming can be provided in a physical storage or transmission medium. A computer receiving the instructions can then execute the algorithm and/or process data obtained from the subject method. Examples of storage media that are computer-readable include floppy disks, magnetic tape, DVD, CD-ROM, a hard disk drive, a ROM or integrated circuit, a magneto-optical disk, or a computer readable card such as a PCMCIA card and the like, whether or not such devices are internal or external to the computer. A file containing information can be “stored” on computer readable medium, where “storing” means recording information such that it is accessible and retrievable at a later date by a computer on a local or remote network.

The computer readable medium may be employed in conjunction with the control device and the cartridge holder in a system for performing the method described below. In certain embodiments, instructions for performing the method are stored on the computer readable medium. Upon initiation of the method, the control device may access and execute the instructions, thereby controlling the operation of the cartridge holder. The cartridge holder may be configured to operate for an extended period of time, e.g., overnight, without any further user input. The cartridge holder may be employed to change cartridge holders in an automatically way, without user input, until the end of an experiment or a series of experiments.

### Reports

In particular embodiments, the cartridge holder may be configured to provide a report of, e.g., how many times each of the cartridges was used, pressure increase for each cartridge, or the time at which each of the cartridges was replaced, etc. This report may be analyzed after an experiment in order to troubleshoot problems or potentially identify optimal cartridge use for future samples. In one embodiment, the report may indicate, for each cartridge, various details about the cartridge during its use. Cartridge Holder

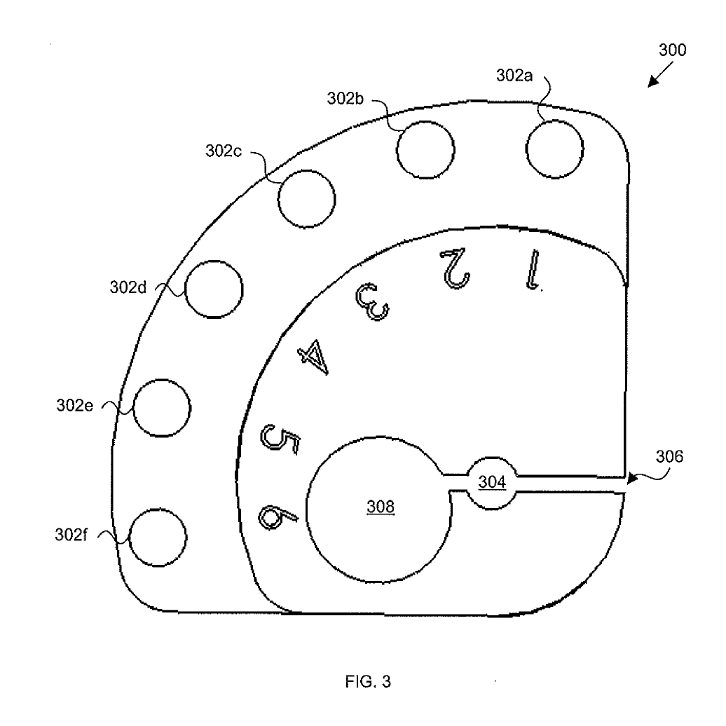

Referring now to FIG. 3, a cartridge holder 300 is depicted according to one embodiment of the invention. As discussed herein, cartridge holder 300 includes a plurality of receptacles 302a-302f adapted to receive cartridges 100. Cartridge holder 300 can include a hole 304 for coupling with a rotational shaft (not depicted). Cartridge holder can optionally be fabricated with a channel 306 extending through hole 304 and terminating in a relief 308 that allows for channel 306 to expand to slide over the rotational shaft for mounting without the need to move any fasteners on the rotational shaft.

Integration with Liquid Chromatography and/or Mass Spectrometry Devices

The cartridge changer 200 described herein can be coupled with various scientific instruments including liquid chromatography devices and/or mass spectrometry devices.

For example, the cartridge changer 200 can be integrated with the RAPIDFIRE® devices available from Biocius Life Sciences, Inc. and described in U.S. Pat. No. 7,588,725; U.S. Patent Application Publication Nos. 2005/0123970 and 2010/0024527; International Publication Nos. WO 2009/059286 and WO 2009/059292.

### Chromatography Methods

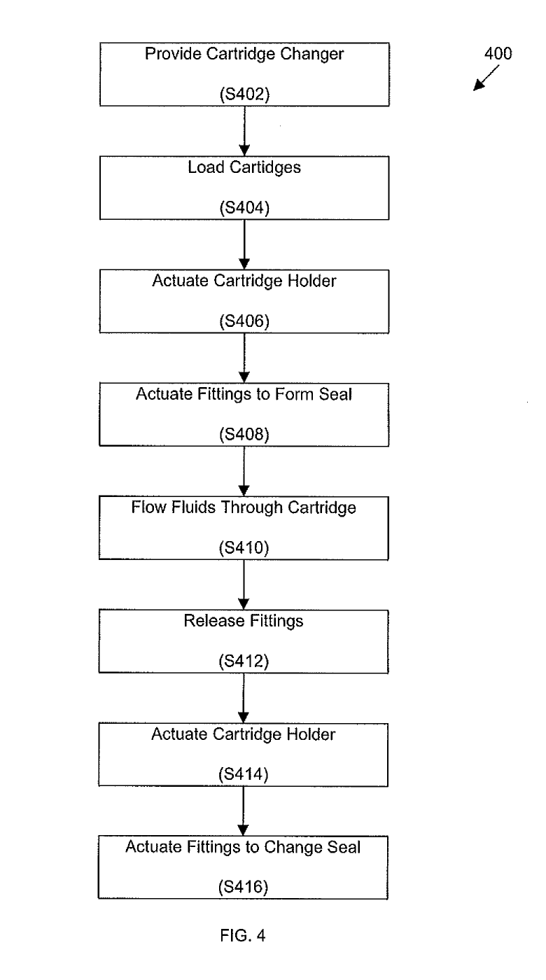

Referring now to FIG. 4, a method 400 of chromatography is provided.

In step S402, a cartridge changer 402 is provided. The cartridge changer can be a cartridge changer as described herein.

In step S404, a plurality of cartridges are loaded into the receptacles of the cartridge changer. The cartridges can be loaded by hand or by automated devices.

In step S406, the cartridge holder is actuated to place a desired cartridge between the fittings of the cartridge changer.

In step S408, the fittings are pressed against the desired cartridge to form a seal.

In step S410, one or more fluids are flowed through the cartridge. These fluids can be flowed in one or two directions and can be collected for further analysis. For example, in reverse elution mass spectrometry, a sample can be passed over the cartridge in a first direction, followed by an elution solvent in the opposite direction. This elution solvent (along with the eluted solutes) can be then presented to a mass spectrometer for analysis.

In step S412, the fittings are retracted to release the seal. Optionally, the cartridge holder is vibrated for a short period (e.g., about one second) to release the cartridge if it is stuck to one of the fittings.

In step S414, the cartridge holder is actuated to place a second desired cartridge between the fittings of the cartridge changer.

In step S416, the fittings are pressed against the desired cartridge to form a seal.

### First Working Example

An experiment was designed to analyze a set of 5,000 individual samples using the RAPIDFIRE® 300 high-throughput mass spectrometry system available from Biocius Life Sciences, Inc. The RAPIDFIRE® system used a form of chromatography known as solid-phase extraction (SPE) to purify the samples in preparation for analysis by mass spectrometry. Prior to the initiation of the experiment, a method was developed that utilized a specific chromatography cartridge containing silica particles coated with C4 chemistry.

A total of six identical cartridges containing C4 chemistry were loaded into the cartridge holder by dropping them into each of the six positions. The performance of the chromatography cartridges tend to decline over multiple analyses due to fine particles within the samples being trapped within the cartridge and its frits, some test compounds or analytes precipitating within the cartridge, and the potential of some test compounds to bind to the cartridge irreversibly. Under routine analysis a pressure of 40 bar (˜600 psi) is generated under these conditions. Most of these confounding problems result in an increase in the operating pressure of the RAPIDFIRE® system since they tend to constrict the flow of fluid through the column.

Therefore the software program was instructed such that if a pressure reading of 48 bar (˜720 psi) was detected to automatically actuate the column changer such that the next cartridge in the device is used for the remaining samples. Additionally, a second setting was specified in the software such that a new cartridge will be used after 1,000 samples regardless of the pressure of the system.

### Second Working Example

Another experiment using the RAPIDFIRE® system was designed to determine the best chromatography column to analyze a set of 20 compounds is designed. In this experiment, three different cartridge chemistries were used including a C4, C18, and phenyl. The software was programmed such that each of the 20 samples was analyzed sequentially by the three cartridges. At the end of the experiment, the data was analyzed to determine the specific type of chromatography cartridge that had the best performance.

### EQUIVALENTS

Although preferred embodiments of the invention have been described using specific terms, such description is for illustrative purposes only, and it is to be understood that changes and variations may be made without departing from the spirit or scope of the following claims.

### INCORPORATION BY REFERENCE

The entire contents of all patents, published patent applications, and other references cited herein are hereby expressly incorporated herein in their entireties by reference.

1. A cartridge changer for a plurality of cartridges, the cartridge changer comprising:
a cartridge holder having a plurality of receptacles each adapted to receive one of the plurality of chromatography cartridges; and
a pair of fittings adapted to releasably engage one of the plurality of chromatography cartridges.

2. The cartridge changer of claim 1, wherein the receptacles are arranged substantially radially on the cartridge holder.

3. The cartridge changer of claim 1, wherein the receptacles are arranged substantially linearly on the cartridge holder.

4. The cartridge changer of claim 1, further comprising:
an actuator adapted to position the cartridge holder for engagement of one of the plurality of cartridges.

5. The cartridge changer of claim 1, wherein the actuator is adapted to rotate the cartridge holder.

6. The cartridge changer of claim 1, wherein the actuator is adapted to advance and retract the cartridge holder.

7. The cartridge changer of claim 1, wherein the actuator is an electric motor or pneumatic actuator.

8. The cartridge changer of claim 1, wherein each of the pair of fittings are mounted on one of a pair of arms.

9. The cartridge changer of claim 1, wherein one of the pair of fittings is coupled to mass spectrometer.

10. The cartridge changer of claim 1, further comprising:
a control device configured to control the actuation of the cartridge holder and the pair of fittings to enable the selection of a specific cartridge.

11. The cartridge changer of claim 10, wherein said control device is programmable to replace cartridges in accordance with user instructions.

12. The cartridge changer of claim 11, wherein the control device is configured to select a new cartridge when a substantially elevated pressure is detected.

13. A method of chromatography, the method comprising:
providing a cartridge changer for a plurality of chromatography cartridges, the cartridge changer comprising:
a cartridge holder having a plurality of receptacles each adapted to receive one of the plurality of cartridges; and
a pair of fittings adapted to releasably engage one of the plurality of cartridges;
loading a plurality of chromatography cartridges in the plurality of receptacles;
actuating the cartridge holder to place a desired cartridge between the pair of fittings; and
actuating the pair of fittings to releasably engage a first of the plurality of cartridges.

14. The method of claim 13, further comprising:
actuating the cartridge holder to place a second desired cartridge between the pair of fittings.

15. The method of claim 14, further comprising:
actuating the pair of fittings to releasably engage the second desired cartridge.

16. The method of claim 13, further comprising:
utilizing the pair of fittings to pass a sample over the desired cartridge.

17. The method of claim 16, further comprising:
utilizing the pair of fittings to pass an elution solvent over the desired cartridge.

18. A computer readable medium comprising instructions for controlling the cartridge changer of claim 1.

19. A system comprising:
a) the computer readable medium of claim 18; and
b) a controller device that is operably connected to said computer readable medium, wherein said system is configured to control a cartridge changer comprising:
a cartridge holder having a plurality of receptacles each adapted to receive one of the plurality of chromatography cartridges; and
a pair of fittings adapted to releasably engage one of the plurality of cartridges.

20. The system of claim 19, further comprising:
a cartridge changer for a plurality of cartridges, the cartridge changer comprising:
a cartridge holder having a plurality of receptacles each adapted to receive one of the plurality of chromatography cartridges; and
a pair of fittings adapted to releasably engage one of the plurality of cartridges,
wherein said controller device operates said cartridge changer in accordance with said programming.
